(19) United States
(12) Patent Application Publication
(10) Pub. No.: US 2014/0349013 A1
(43) Pub. Date: Nov. 27, 2014

(54) METHOD OF MANUFACTURING A LOW VOLUME TRANSFER ANILOX ROLL FOR HIGH-RESOLUTION FLEXOGRAPHIC PRINTING

(71) Applicants: Ed S. Ramakrishnan, Spring, TX (US); Robert J. Petcavich, The Woodlands, TX (US)

(72) Inventors: Ed S. Ramakrishnan, Spring, TX (US); Robert J. Petcavich, The Woodlands, TX (US)

(73) Assignee: UNI-PIXEL DISPLAYS, INC., The Woodlands, TX (US)

(21) Appl. No.: 13/901,524

(22) Filed: May 23, 2013

(51) Int. Cl. B05D 3/12; B05C 9/08

(52) U.S. Cl. CPC B05D 3/12; B05C 9/08
USPC 427/270; 118/258

(57) ABSTRACT

A method of manufacturing a low volume transfer anilox roll includes depositing a first coating material over a contact surface of a cylinder. A plurality of cells are patterned into the contact surface of the cylinder. A second coating material is deposited over the patterned contact surface of the cylinder.

### BACKGROUND OF THE INVENTION

An electronic device with a touch screen allows a user to control the device by touch. The user may interact directly with the objects depicted on the display through touch or gestures. Touch screens are commonly found in consumer, commercial, and industrial devices including smartphones, tablets, laptop computers, desktop computers, monitors, gaming consoles, and televisions. A touch screen includes a touch sensor that includes a pattern of conductive lines disposed on a substrate.

Flexographic printing is a rotary relief printing process that transfers an image to a substrate. A flexographic printing process may be adapted for use in the fabrication of touch sensors. In addition, a flexographic printing process may be adapted for use in the fabrication of flexible and printed electronics.

### BRIEF SUMMARY OF THE INVENTION

According to one aspect of one or more embodiments of the present invention, a method of manufacturing a low volume transfer anilox roll includes depositing a first coating material over a contact surface of a cylinder. A plurality of cells are patterned into the contact surface of the cylinder. A second coating material is deposited over the patterned contact surface of the cylinder.

According to one aspect of one or more embodiments of the present invention, a low volume transfer anilox roll includes a cylinder. A roller mount is disposed on a distal end of the cylinder. A first coating layer is disposed on a longitudinal contact surface around the cylinder. A plurality of cells are patterned into the cylinder. A second coating layer is disposed over the patterned plurality of cells.

Other aspects of the present invention will be apparent from the following description and claims.

### BRIEF DESCRIPTION OF THE DRAWINGS

FIG. 1 shows a portion of a conductive pattern design on a flexible and transparent substrate having junctions between lines or features of different widths or orientations in accordance with one or more embodiments of the present invention.

FIG. 2 shows a flexographic printing system in accordance with one or more embodiments of the present invention.

FIG. 3 shows a conventional anilox roll used in a flexographic printing process.

FIG. 4 shows a cross-sectional view of the conventional anilox roll used in the flexographic printing process.

FIG. 5 shows a method of manufacturing a conventional anilox roll used in the flexographic printing process.

FIG. 6 shows a low volume anilox roll in accordance with one or more embodiments of the present invention.

FIG. 7 shows a cross-sectional view of the low volume anilox roll in accordance with one or more embodiments of the present invention.

FIG. 8 shows a method of manufacturing the low volume transfer anilox roll in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

A conventional flexographic printing system uses a conventional anilox roll (sometimes referred to a meter roll) to transfer ink or other material to a flexographic printing plate (sometimes referred to as a flexo master). The flexographic printing plate includes one or more embossing patterns, or raised projections, that have distal ends onto which the ink or other material may be deposited by the conventional anilox roll. In operation, the inked flexographic printing plate transfers an ink image of the one or more embossing patterns to a substrate as part of a flexographic printing process.

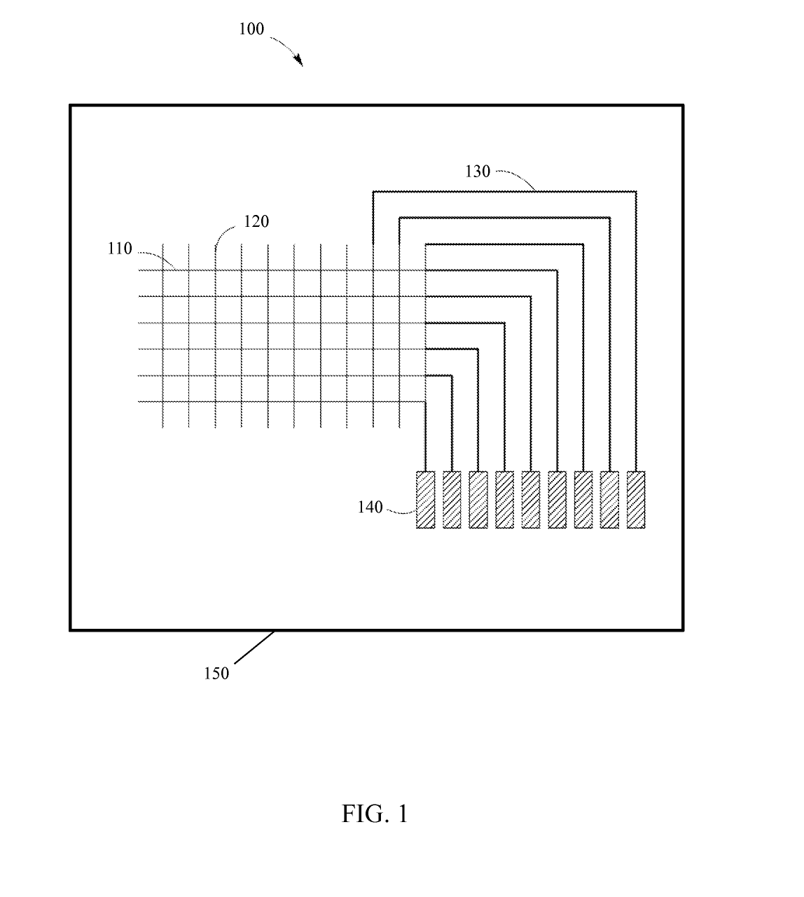

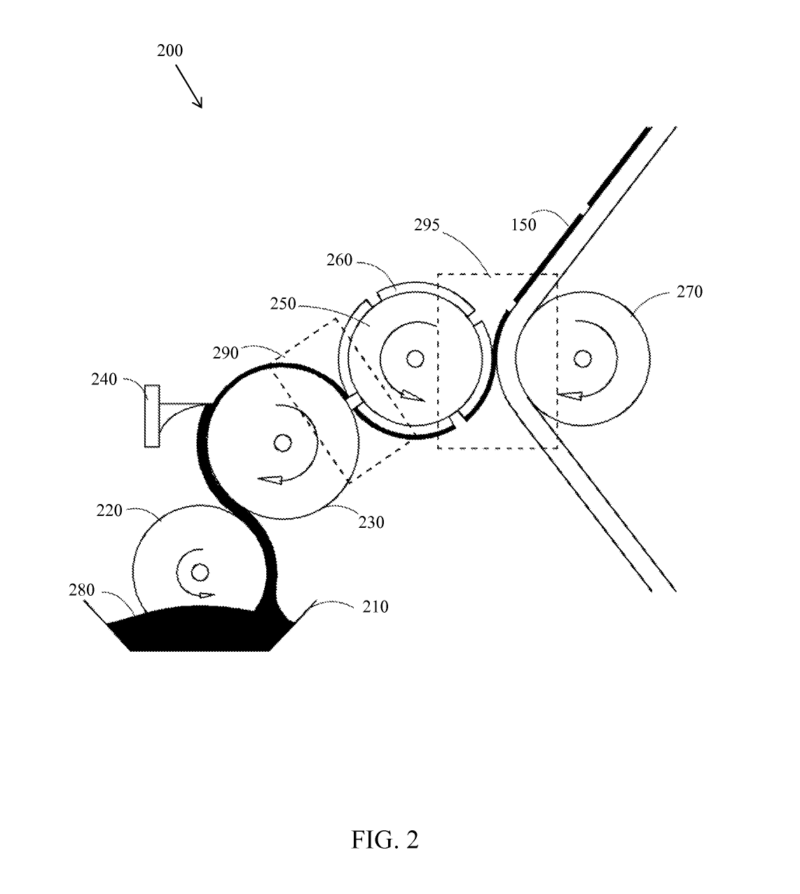

FIG. 1 shows a portion of a conductive pattern design 100 on a flexible and transparent substrate 150 having junctions between conductive lines or features of different widths or orientations in accordance with one or more embodiments of the present invention. Two or more conductive pattern designs 100 disposed on opposing sides of substrate 150 may form a projected capacitance touch sensor (not independently illustrated). In certain embodiments, each conductive pattern design 100 may include a micro-mesh network formed by a plurality of parallel x-axis conductive lines 110 that are perpendicular or angled with respect to a plurality of parallel y-axis conductive lines 120. A plurality of interconnect conductive lines 130 may route x-axis conductive lines 110 and y-axis conductive lines 120 to a plurality of connector conductive lines 140. The plurality of connector conductive lines 140 may be configured to provide a connection to an interface (not shown) to a touch sensor controller (not shown) that detects touch through the touch sensor (not shown). In one or more embodiments of the present invention, x-axis conductive lines 110, y-axis conductive lines 120, interconnect conductive lines 130, and connector conductive lines 140 may be formed by electroless plating a conductive metal over x-axis seed lines (not shown), y-axis seed lines (not shown), interconnect seed lines (not shown), and connector seed lines (not shown) printed by a flexographic printing system (200 of FIG. 2) using a catalytic ink (280 of FIG. 2). In other embodiments, x-axis conductive lines 110, y-axis conductive lines 120, interconnect conductive lines 130, and connector conductive lines 140 may be printed directly on substrate 150 without electroplating or electroless plating.

In certain embodiments, one or more of x-axis conductive lines 110, y-axis conductive lines 120, interconnect conductive lines 130, and connector conductive lines 140 may have different line widths or different orientations. The number of x-axis conductive lines 110, the line-to-line spacing between x-axis conductive lines 110, the number of y-axis conductive lines 120, and the line-to-line spacing between y-axis conductive lines 120 may vary based on an application. One of ordinary skill in the art will recognize that the size, configuration, and design of conductive pattern design 100 may vary in accordance with one or more embodiments of the present invention.

In one or more embodiments of the present invention, one or more of x-axis conductive lines 110 and one or more of y-axis conductive lines 120 may have a line width less than approximately 10 micrometers. In one or more embodiments of the present invention, one or more of x-axis conductive lines 110 and one or more of y-axis conductive lines 120 may have a line width in a range between approximately 10 micrometers and approximately 50 micrometers. In one or more embodiments of the present invention, one or more of x-axis conductive lines 110 and one or more of y-axis conductive lines 120 may have a line width greater than approximately 50 micrometers. One of ordinary skill in the art will recognize that the shape and width of one or more x-axis conductive lines 110 and one or more y-axis conductive lines 120 may vary in accordance with one or more embodiments of the present invention.

In one or more embodiments of the present invention, one or more of interconnect conductive lines 130 may have a line width in a range between approximately 50 micrometers and approximately 100 micrometers. One of ordinary skill in the art will recognize that the shape and width of one or more interconnect conductive lines 130 may vary in accordance with one or more embodiments of the present invention. In one or more embodiments of the present invention, one or more of connector conductive lines 140 may have a line width greater than approximately 100 micrometers. One of ordinary skill in the art will recognize that the shape and width of one or more connector conductive lines 140 may vary in accordance with one or more embodiments of the present invention.

FIG. 2 shows a flexographic printing system 200 in accordance with one or more embodiments of the present invention. Flexographic printing system 200 may include an ink pan 210, an ink roll 220 (also referred to as a fountain roll), an anilox roll 230, a doctor blade 240, a printing plate cylinder 250, a flexographic printing plate 260, and an impression cylinder 270. In operation, ink roll 220 transfers ink 280 from ink pan 210 to anilox roll 230. In certain embodiments, ink 280 may be a catalytic ink or catalytic alloy ink that serves as a plating seed suitable for metallization by electroless plating. One of ordinary skill in the art will recognize that the composition of ink 280 may vary in accordance with one or more embodiments of the present invention. Doctor blade 240 removes excess ink 280 from anilox roll 230. In transfer area 290, anilox roll 230 meters the amount of ink 280 transferred to flexographic printing plate 260 to a uniform thickness. Printing plate cylinder 250 is typically made of metal and the surface may be plated with chromium, or the like, to provide increased abrasion resistance. Flexographic printing plate 260 may be mounted to printing plate cylinder 250 by an adhesive (not shown).

Substrate 150 moves between printing plate cylinder 250 and impression cylinder 270. In certain embodiments, substrate 150 may be flexible and transparent. Transparent means the transmission of visible light with a transmittance rate of 85% or more. In one or more embodiments of the present invention, substrate 150 may be polyethylene terephthalate (“PET”), polyethylene naphthalate (“PEN”), cellulose acetate (“TAC”), linear low-density polyethylene (“LLDPE”), bi-axially-oriented polypropylene (“BOPP”), acrylic, epoxy polyimide, polyester, polypropylene, polyurethane, glass, or combinations thereof. One of ordinary skill in the art will recognize that the composition of substrate 150 may vary in accordance with one or more embodiments of the present invention. Impression cylinder 270 applies pressure to printing plate cylinder 250, transferring an image from embossing patterns of flexographic printing plate 160 onto substrate 150 at transfer area 295. The rotational speed of printing plate cylinder 250 is synchronized to match the speed at which substrate 150 moves through flexographic printing system 200. In certain embodiments, the speed may vary between 20 feet per minute to 750 feet per minute.

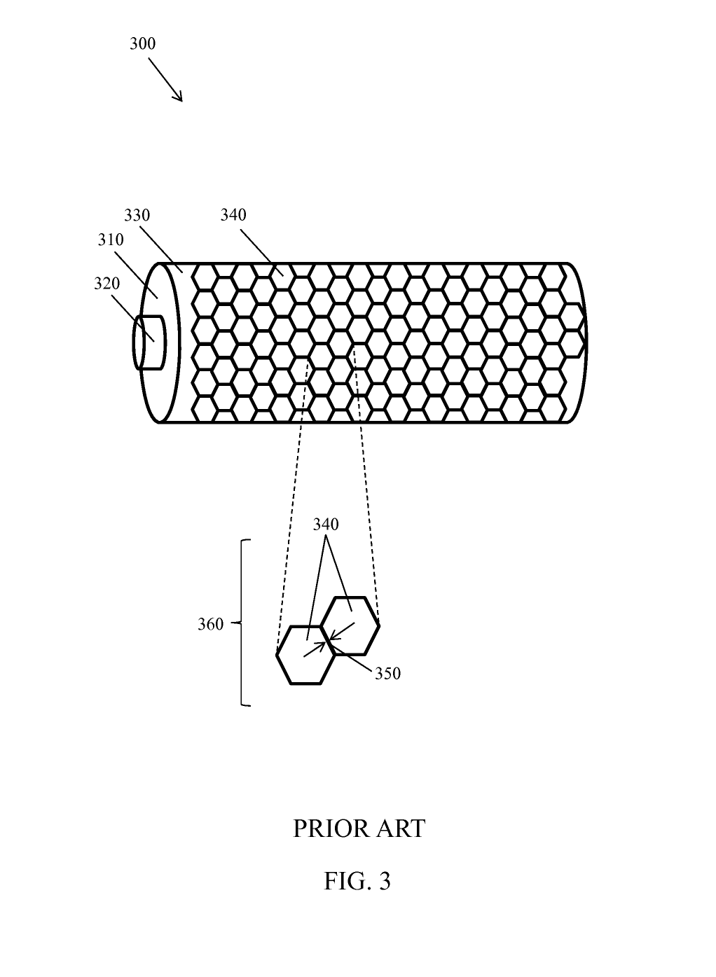

FIG. 3 shows a conventional anilox roll 300 used in a flexographic printing process. Conventional anilox roll 300 controls, in part, the volume of ink or other material transferred to a flexographic printing plate (not shown) during the flexographic printing process. Conventional anilox roll 300 includes a rigid cylinder 310 constructed of steel, a carbon fiber composite, a carbon fiber composite covered with metal, chrome, or an aluminum core with steel. One or more roller mounts 320 are disposed on the distal ends of cylinder 310 to secure and rotate cylinder 310 during the flexographic printing process. Prior to deposition, cylinder 310 is polished so that a longitudinal contact surface around cylinder 310 is smooth. A hard ceramic coating 330 is deposited on the longitudinal contact surface around cylinder 310. After deposition, ceramic coating 330 is polished so that a longitudinal contact surface of ceramic coating 330 around cylinder 310 is smooth. The ceramic coating 330 is polished smooth because it is the contact surface of the cylinder. However, the polishing process is difficult, time-consuming, and expensive as ceramics are hard.

A plurality of cells 340 are patterned into ceramic coating 330, but do not extend into cylinder 310. Each cell 340 is a small indentation of a predetermined geometry in the ceramic coating 330 that holds and meters the amount of ink (not shown) or other material (not shown) transferred to the flexographic printing plate (not shown) during the flexographic printing process. A close-up view 360 shows a common wall 350 formed by adjacent cells 340. For the cell 340 geometry depicted in the figure, a given cell 340 shares a common wall 350 with six neighboring cells 340. However, the number of common walls 350 shared by a given cell 340 may vary depending on the geometry of the cell 340 used in an application.

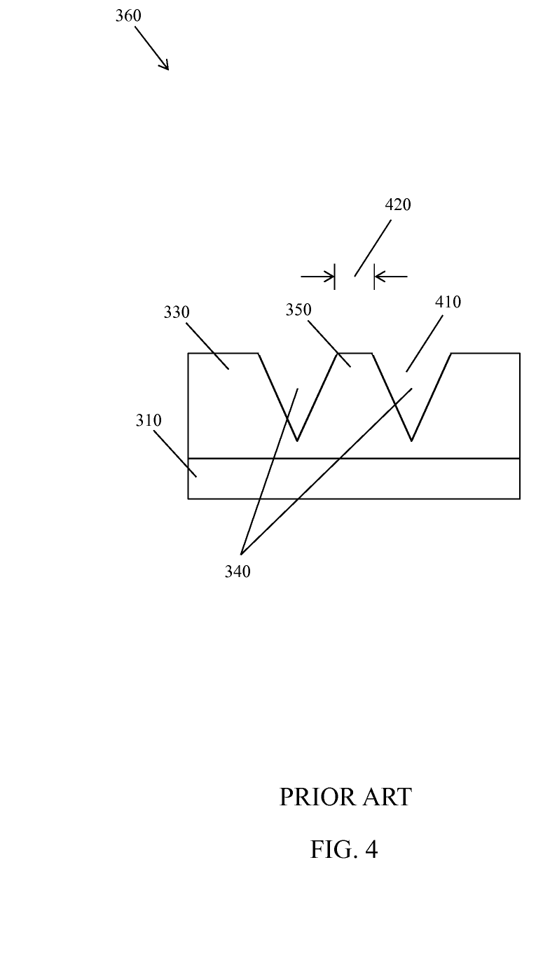

FIG. 4 shows a cross-sectional view 360 of conventional anilox roll 300 used in the flexographic printing process. Ceramic coating 330 covers the longitudinal contact surface of cylinder 310 and has a thickness of at least 10 micrometers. A plurality of cells 340 are patterned into ceramic coating 330, but do not extend into cylinder 310. The volume of ink (not shown) or other material (not shown) held by a given cell 340 is measured in units of Billion Cubic Microns (“BCMs”). A given cell 340 holds a volume of at least 1 BCM or more of ink (not shown) or other material (not shown) suitable for printing standard geometry lines and features. Each cell 340 has a width (not shown) of 10 micrometers or more.

In the cross-section depicted, common wall 350 is formed by adjacent cells 340 patterned into ceramic coating 330. Common wall 350 is composed entirely of ceramic coating 330 and has a thickness 420 determined by the cell 340 density. As the cell 340 density increases, the thickness 420 of common wall 350 decreases. If the thickness 420 of common wall 350 becomes too thin, it may break from contact with the chambered doctor blade (not shown) or the flexographic printing plate (not shown) during the flexographic printing process or wear out over time from repeated use. If the common wall 350 between adjacent cells 340 breaks, a substantially larger cell (not shown) is formed, resulting in inconsistent transfer volumes. Inconsistent transfer volumes can result in print quality issues due to excess inking. As a consequence, the cell 340 density may be limited by a minimally sufficient common wall 350 thickness 420 necessary for reliable use. Typically, common wall 350 has a thickness 420 of 10 micrometers or more, suitable for printing standard geometry lines and features.

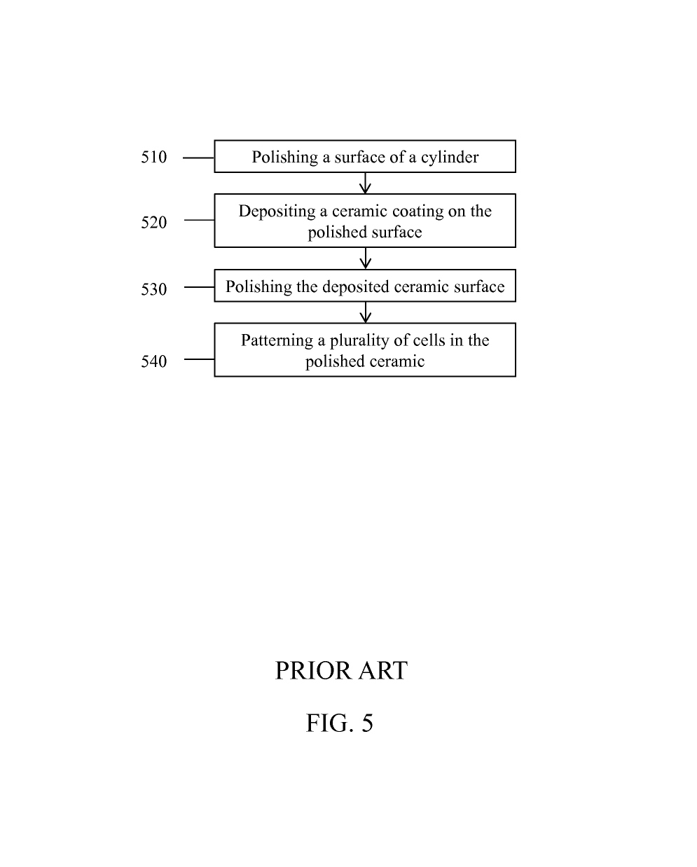

FIG. 5 shows a method of manufacturing conventional anilox roll 300. In step 510, a longitudinal contact surface of a rigid metal cylinder is polished smooth. The cylinder is polished smooth such that a predetermined thickness of material may be evenly deposited around the cylinder. In step 520, a ceramic coating is deposited on the longitudinal contact surface of the cylinder. The deposited ceramic coating typically has a thickness of at least 10 micrometers and is typically composed of a hard ceramic material, such as chromium oxide. While there are harder ceramics available, they are difficult to use because the harder the ceramic, the more difficult it is to polish and pattern the ceramic. In step 530, a longitudinal contact surface of the deposited ceramic coating on the cylinder is polished smooth. The polished ceramic coating typically has a roughness average, Rₐ, of at least 3 micro-inches or more. In step 540, a plurality of cells are patterned into the polished ceramic coating, but do not extend into the metal of the cylinder. In operation, the conventional anilox roll transfers ink (not shown) to a flexographic printing plate (not shown) of a flexographic printing system (not shown) suitable for printing standard geometry lines and features.

When printing fine lines or features with a width less than 10 micrometers, the volume of ink required for each cell may be substantially less than 1 BCM and the density of cells required may be substantially higher than that of a conventional anilox roll. As a consequence, conventional anilox rolls are ineffective for printing fine lines or features in the micrometer range. This is because, in part, the ceramic coating of the conventional anilox roll is porous and patterning cells with a volume less than 1 BCM may result in very thin ceramic walls between adjacent cells that are subject to breakage.

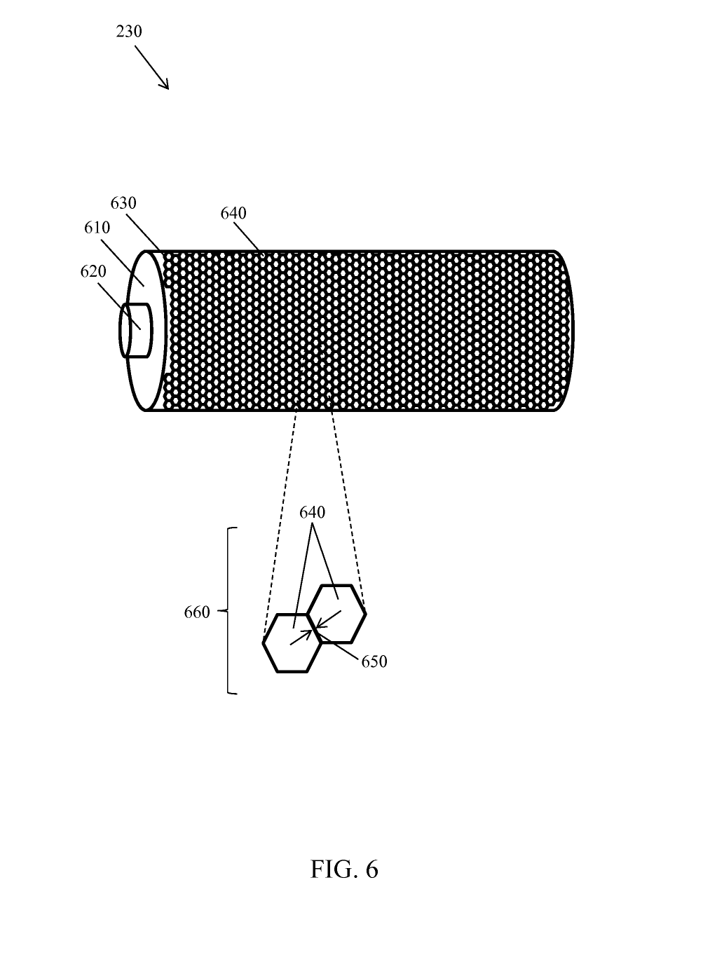

FIG. 6 shows a low volume transfer anilox roll 600 in accordance with one or more embodiments of the present invention. Anilox roll 230 may be used as part of flexographic printing system 200 described above with reference to FIG. 2. Anilox roll 230 controls, in part, the volume of ink or other material transferred to a flexographic printing plate (e.g., 260 of FIG. 2) during flexographic printing (e.g., FIG. 2). In one or more embodiments of the present invention, anilox roll 230 comprises a rigid cylinder 610 constructed of steel, a carbon fiber composite, a carbon fiber composite covered with metal, chrome, or an aluminum core with steel. One of ordinary skill in the art will recognize that cylinder 610 may be composed of other materials in accordance with one or more embodiments of the present invention. Cylinder 610 may have a diameter (not shown) in a range between approximately 1 inch and approximately 50 inches depending on the type (narrow, mid, or wide) of web printer (not shown) used. Cylinder 610 may have a length (not shown) suitable for a given web length (not shown). One of ordinary skill in the art will recognize that the diameter (not shown) and the length (not shown) of cylinder 610 may vary in accordance with one or more embodiments of the present invention.

One or more roller mounts 620 may be disposed on the distal ends of cylinder 610 to secure and rotate cylinder 610 during flexographic printing. In certain embodiments, a longitudinal contact surface (not shown) around cylinder 610 may be rough so that the contact surface is uneven. A first coating material (not shown) may be deposited over the contact surface of cylinder 610 forming a thin and smooth layer of the first coating material (not shown). The first coating material (not shown) may be composed of chromium, copper, nickel, tungsten, titanium, molybdenum, other metals, or metal alloys. In one or more embodiments, the first coating material (not shown) may be deposited by a chemical vapor deposition (“CVD”) process, a plasma enhanced chemical vapor deposition (“PECVD”) process, an atmospheric plasma enhanced chemical vapor deposition (“APCVD”) process, or a physical vapor deposition (“PVD”) process including sputtering and electron beam evaporation. One of ordinary skill in the art will recognize that other deposition processes may be used in accordance with one or more embodiments of the present invention. The deposited first coating material (not shown) may have a thickness in a range between approximately 1 nanometer and several micrometers. One of ordinary skill in the art will recognize that the thickness of the deposited first coating material (not shown) may vary in accordance with one or more embodiments of the present invention.

A plurality of cells 640 may be patterned into cylinder 610. Each cell 640 may be a small indentation of a predetermined geometry that holds and meters the amount of ink (not shown) or other material (not shown) transferred to a flexographic printing plate (e.g., 260 of FIG. 2) during flexographic printing. In one or more embodiments, the predetermined geometry may be hexagonal, elongated hexagons, tri-helical, pyramid, inverted pyramid, or quadrangular. One of ordinary skill in the art will recognize that the geometry of each cell may vary in accordance with one or more embodiments of the present invention. The patterned plurality of cells 640 extend into the metal of cylinder 610. Patterning the plurality of cells 640 into cylinder 610 may simplify the manufacturing process because patterning metal may be easier than patterning ceramic. One of ordinary skill in the art will recognize that the number, geometry, size, and transfer volume of cells 640 may vary in accordance with one or more embodiments of the present invention. A close-up view 660 shows a common wall 650 formed by adjacent cells 640. For the cell 640 geometry depicted in the figure, a given cell 640 may share a common wall 350 with six neighboring cells. One of ordinary skill in the art will recognize that the number of common walls 650 shared by a given cell 640 may vary depending on the geometry of cell 640 in accordance with one or more embodiments of the present invention.

In one or more embodiments of the present invention, each cell 640 may have a width (not shown) less than 10 micrometers. In certain embodiments, each cell 640 may have a width (not shown) less than 5 micrometers. In other embodiments, each cell 640 may have a width (not shown) less than 1 micrometer. One of ordinary skill in the art will recognize that for a given geometry, a smaller width provides a smaller volume of ink (not shown) or other material (not shown).

A second coating material 630 may be deposited over the patterned contact surface of cylinder 610 that includes the patterned plurality of cells 640. In one or more embodiments of the present invention, the second coating material 630 may be composed of oxides, nitrides, borides, and carbides of metals including, but not limited to, aluminum, cerium, zirconium, hafnium, titanium, tungsten, molybdenum, and intermetallic compounds. In certain embodiments, where the second coating material 630 is sourced from solid phase materials, the second coating material 630 may be deposited by a CVD process, a PECVD process, an APCVD process, or a PVD process including sputtering and electron beam evaporation. In other embodiments, where the second coating material 630 is sourced from liquid phase materials, the second coating material 630 may be deposited by a spray coating process, a spin coating process, or a dip coating process. One of ordinary skill in the art will recognize that other deposition processes may be used in accordance with one or more embodiments of the present invention.

While the patterned plurality of cells 640 extend into the metal cylinder 610, the entire contact surface of cylinder 610, including the patterned plurality of cells 640, are covered by the second coating material 630. The deposited second coating material 630 may have a thickness in a range between approximately 1 nanometer and several micrometers. In certain embodiments, anilox roll 230 may include a plurality of cells 640 having a predetermined width (not shown) patterned into the metal of cylinder 610. If an application requires a smaller volume of ink transfer, the thickness (not shown) of second coating material 630 may be increased to reduce the width (not shown) and the volume (not shown) of one or more cells 640. In this way, a standard width geometry may be patterned into the metal of cylinder 610, but a smaller width (not shown) and volume (not shown) may be achieved by controlling the thickness (not shown) of the second coating material layer 630. In other embodiments, the thickness (not shown) of second coating material layer 630 may be controlled to produce different width and volume cells 640 in different areas of anilox roll 230. In this way, a single anilox roll may be used to print features requiring different volumes of ink transfer. One of ordinary skill in the art will recognize that the thickness (not shown) of the deposited second coating material 630 may vary in accordance with one or more embodiments of the present invention.

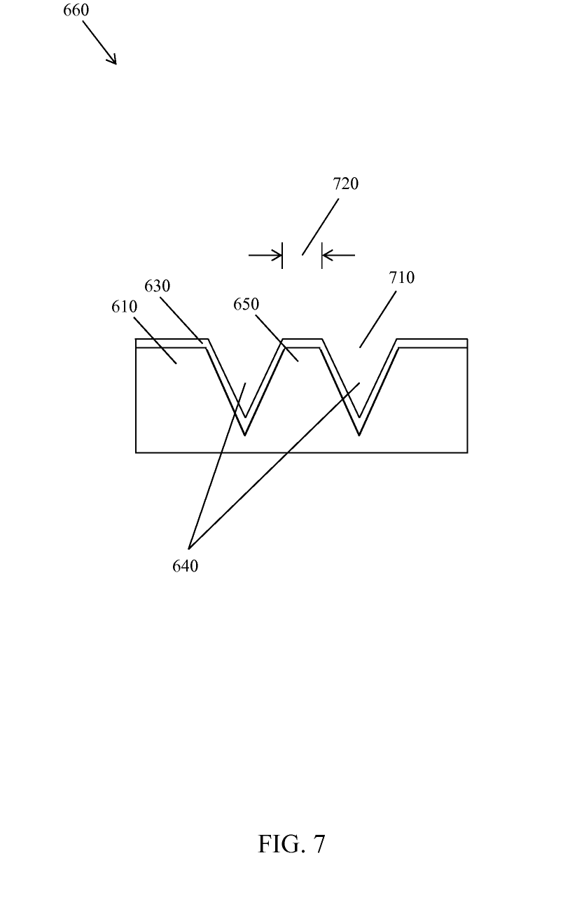

FIG. 7 shows a cross-sectional view of the low volume transfer anilox roll 600 in accordance with one or more embodiments of the present invention. The plurality of cells 640 may be patterned into cylinder 610, extending into the metal of cylinder 610. The second coating material 630 may cover the patterned contact surface of cylinder 610. The deposited second coating material 630 may have a thickness in a range between approximately 1 nanometer and several micrometers. In certain embodiments, a given cell 640, coated by second coating material 630, may hold a volume 710 of 0.3 BCM or less of ink (not shown) or other material (not shown). In other embodiments, a given cell 640, coated by second coating material 630, may hold a volume 710 of approximately 0.5 BCM or less of ink (not shown) or other material (not shown). In still other embodiments, a given cell 640, coated by second coating material 630, may hold a volume 710 of approximately 1 BCM or less of ink (not shown) or other material (not shown). In certain embodiments, the thickness (not shown) of second coating material 630 may be increased to reduce the width (not shown) and volume (not shown) of one or more cells 640. One of ordinary skill in the art will recognize that the number, geometry, size, and transfer volume of cells 640, and the thickness of the second coating material 630 may vary in accordance with one or more embodiments of the present invention.

In the cross-section depicted, common wall 650 may be formed by adjacent cells 640 patterned into cylinder 610. Common wall 650 may be composed of the metal of cylinder 610 covered by the second coating material 630. Common wall 650 may have a thickness 720 in a range between approximately 1 nanometer and several micrometers. As the cell density increases, the common wall thickness may decrease. Because common wall 650 is composed of metal, it is easier to pattern than the patterned ceramic used in the conventional anilox roll (300 of FIG. 3) and is stronger. Once coated in ceramic, common wall 650 provides a wear resistant surface. The coated surface of common wall 650, that contacts the chambered doctor blade (240 of FIG. 2), resists abrasion and cell 640 sizes remain constant resulting in a consistent low volume transfers of ink (not shown) or other material (not shown) suitable for printing fine lines or features.

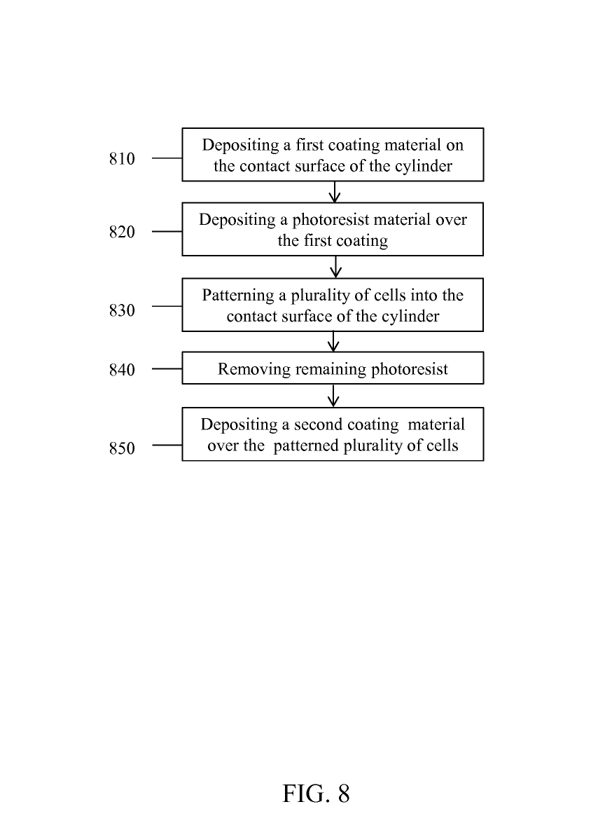

FIG. 8 shows a method of manufacturing the low volume transfer anilox roll 600 in accordance with one or more embodiments of the present invention. The low volume transfer anilox roll may include a rigid cylinder composed of steel, a carbon fiber composite, a carbon fiber composite covered with metal, chrome, or an aluminum core with steel. The cylinder may have a diameter in a range between approximately 1 inch and approximately 50 inches depending on the type (narrow, mid, or wide) of web printer used. The cylinder may have a length suitable for a given web length. One of ordinary skill in the art will recognize that the diameter and the length of the cylinder may vary based on an application in accordance with one or more embodiments of the present invention. A longitudinal contact surface around the cylinder may be rough.

In step 810, a first coating material may be deposited over the contact surface of the cylinder forming a thin and smooth layer of first coating material. Because the first coating material forms a thin and smooth layer over the rough cylinder, polishing the cylinder prior to deposition of the first coating material may not be required. The first coating material may be composed of chromium, copper, nickel, tungsten, titanium, molybdenum, other metals, or metal alloys. The deposited first coating material may have a thickness in a range between approximately 1 nanometer and several micrometers.

In step 820, a photoresist material may be deposited over the deposited first coating material. In certain embodiments, the photoresist material may be positive-type photoresist material that may be dissolved by exposure to UV radiation. In other embodiments, the photoresist material may be negative-type photoresist material that may be polymerized and stabilized by exposure to UV radiation. One of ordinary skill in the art will recognize that positive photoresist or negative photoresist may be used based on an application in accordance with one or more embodiments of the present invention. In certain embodiments, the cylinder with deposited photoresist may optionally be soft-baked at a temperature in a range between approximately 90 degrees Celsius and approximately 110 degrees Celsius for a time period in a range between approximately 30 seconds to approximately 2 minutes to solidify the deposited photoresist. In certain embodiments, where patterning may be performed with maskless lithography or other techniques, photoresist material may not be necessary.

In step 830, a plurality of cells may be patterned into the contact surface of the cylinder. Each cell may be a small indentation of a predetermined geometry that holds and meters the amount of ink or other material transferred to a flexographic printing plate during flexographic printing. In one or more embodiments, the predetermined geometry may be hexagonal, elongated hexagons, tri-helical, pyramid, inverted pyramid, or quadrangular. One of ordinary skill in the art will recognize that the geometry of each cell may vary in accordance with one or more embodiments of the present invention. The patterned plurality of cells extend into the metal of the cylinder. Patterning the plurality of cells into the cylinder may simplify manufacturing because patterning metal may be easier than patterning ceramic. In addition, metal may be patterned with finer features than ceramic. As a consequence, fine lines and features may be patterned into the cylinder, resulting in a higher density of smaller cells than conventional anilox rolls. One of ordinary skill in the art will recognize that the number, geometry, size, and transfer volume of the cells may vary in accordance with one or more embodiments of the present invention.

In one or more embodiments, the plurality of cells may be patterned into the contact surface of the cylinder by a metal master process. In one or more embodiments, the plurality of cells may be patterned into the contact surface of the cylinder by a maskless lithographic process. In one or more embodiments, the plurality of cells may be patterned into the contact surface of the cylinder by an electron beam lithographic process. In one or more embodiments, the plurality of cells may be patterned into the contact surface of the cylinder by an UV lithographic process. In one or more embodiments, the plurality of cells may be patterned into the contact surface of the cylinder by a laser ablation process. One of ordinary skill in the art will recognize that other patterning processes may be used in accordance with one or more embodiments of the present invention. In step 840, if photoresist material was used, photoresist material that remains after patterning may be removed. In certain embodiments, the remaining photoresist may be removed using a vendor recommended solvent. In other embodiments, the reaming photoresist may be removed with organic solvents including acetone, benzene, toluene, and others.

In step 850, a second coating material may be deposited over the patterned plurality of cells that extend into the cylinder. In one or more embodiments of the present invention, the second coating material may be composed of oxides, nitrides, borides, and carbides of metals including, but not limited to, aluminum, cerium, zirconium, hafnium, titanium, tungsten, molybdenum, and intermetallic compounds. In certain embodiments, where the second coating material is sourced from solid phase materials, the second coating material may be deposited by a CVD process, a PECVD process, an APCVD process, or a PVD process including sputtering and electron beam evaporation. In other embodiments, where the second coating material is sourced from liquid phase materials, the second coating material may be deposited by a spray coating process, a spin coating process, or a dip coating process. One of ordinary skill in the art will recognize that other deposition processes may be used in accordance with one or more embodiments of the present invention.

While the patterned plurality of cells extend into the cylinder, the entire contact surface of the cylinder, including the patterned plurality of cells, are covered by the second coating material. The deposited second coating material may have a thickness in a range between approximately 1 nanometer and several micrometers. Because the second coating material is deposited as a thin layer, the deposited second coating material is smooth and does not require polishing. In certain embodiments, the anilox roll may include a plurality of cells having a predetermined width patterned into the metal of the cylinder. If an application requires a smaller volume of ink transfer, the thickness of the second coating material may be increased to reduce the width of one or more cells. In this way, a standard width geometry may be patterned into the metal of the cylinder, but a smaller width and volume may be achieved by controlling the thickness of the second coating material layer. In other embodiments, the thickness of the second coating material layer may be controlled to produce different width and volume cells in different areas of the anilox roll. In this way, a single anilox roll may be used to print features requiring different volumes of ink transfer. One of ordinary skill in the art will recognize that the thickness of the deposited second coating material may vary in accordance with one or more embodiments of the present invention. In certain embodiments, the second coating material may be deposited over the contact surface of the cylinder by exposing the patterned contact surface of the cylinder to high temperatures in a nitrogen, oxygen, or carbon atmosphere.

In certain embodiments, after deposition of the second coating material, the low volume transfer anilox roll may have a density in a range between approximately 1000 lines per inch (“LPI”) and approximately 2000 LPI. In other embodiments, after deposition of the second coating material, the low volume transfer anilox roll may have a density in a range between approximately 2000 LPI and approximately 5000 LPI. In certain embodiments, one or more cells of the patterned plurality of cells, covered by the second coating material, may hold and transfer a volume of 0.3 BCM or less of ink or other material. In other embodiments, one or more cells of the patterned plurality of cells, covered by the second coating material, may hold and transfer a volume of 0.5 BCM or less of ink or other material. In still other embodiments, one or more cells of the patterned plurality of cells, covered by the second coating material, may hold and transfer a volume of 1 BCM or less of ink or other material.

In certain embodiments, the method may be used to manufacture a gravure printing cylinder for use in a gravure printing process. For example, a gravure printing cylinder is typically patterned by laser. This process limits the resolution of the patterns printed on the gravure printing cylinder. The method may be used to etch a copper plated gravure cylinder with fine lines or features. In other embodiments, the method may be used to print a very thin and uniform layer of material onto the surface of the substrate. For example, a thin layer with a thickness in a range between approximately 10 nanometers and approximately 100 nanometers may be coated on the substrate. In still other embodiments, the method may be used to repair a damaged anilox roll to reduce waste and expense.

Advantages of one or more embodiments of the present invention may include one or more of the following:

In one or more embodiments of the present invention, a low volume anilox roll is suitable for use in a flexographic printing system configured to print fine lines and features less than 10 micrometers in width.

In one or more embodiments of the present invention, a low volume anilox roll is suitable for use in a flexographic printing system configured to print fine lines and features less than 50 micrometers in width.

In one or more embodiments of the present invention, a low volume anilox roll includes cells configured to hold and transfer a volume of 0.3 BCM or less of ink or other material.

In one or more embodiments of the present invention, a low volume anilox roll includes cells configured to hold and transfer a volume of 0.5 BCM or less of ink or other material.

In one or more embodiments of the present invention, a low volume anilox roll includes cells configured to hold and transfer a volume 1 BCM or less of ink or other material.

In one or more embodiments of the present invention, a low volume anilox roll includes a plurality of cells patterned into the cylinder itself.

In one or more embodiments of the present invention, a low volume anilox roll includes a plurality of cells patterned into the cylinder, where adjacent cells share common walls formed of the cylinder material.

In one or more embodiments of the present invention, a low volume anilox roll includes a plurality of cells patterned into the cylinder, where the plurality of cells may include features that are sub-micrometer in size with large aspect ratios and high density of pattern distribution per unit area of the anilox roll, thereby providing very small cells with very small and uniform transfer volumes.

In one or more embodiments of the present invention, a low volume anilox roll may use a plurality of cells patterned into a metal of the cylinder that is easier to pattern than the plurality of cells patterned into ceramic of a conventional anilox roll.

In one or more embodiments of the present invention, a low volume anilox roll may have a higher density of smaller cells than a conventional anilox roll. The smaller cells may hold and transfer a uniform volume of ink suitable for printing fine lines and features.

In one or more embodiments of the present invention, a low volume anilox roll may have a higher density of cells than a conventional anilox roll. Because the common walls are formed of the cylinder, the thickness of the common walls may be smaller and stronger, thereby allowing for a higher density of cells than a conventional anilox roll using cells of the same size and geometry.

In one or more embodiments of the present invention, a low volume anilox roll may have smaller cells than a conventional anilox roll. Because the cells are patterned into the cylinder and the common walls are formed of the cylinder, the low volume anilox roll may use smaller cells than the conventional anilox roll.

In one or more embodiments of the present invention, a low volume anilox roll is more reliable, resists wear from repeated use, and has a longer service life than conventional anilox rolls. Because the common walls are formed of the cylinder and the entire contact surface is covered with a ceramic coating, the low volume anilox roll resists breakage of common walls and may transfer a uniform volume of ink for a longer service life than a conventional anilox roll.

In one or more embodiments of the present invention, a low volume anilox roll may use harder ceramic materials than conventional anilox rolls. Because the ceramic coating is thin and smooth, the ceramic does not have to be polished. As a consequence, different and harder ceramic materials may be used.

In one or more embodiments of the present invention, a low volume anilox roll may be used to coat a uniform and thin layer of material on a substrate.

In one or more embodiments of the present invention, a low volume anilox roll improves manufacturing efficiency.

In one or more embodiments of the present invention, a low volume anilox roll reduces manufacturing waste.

In one or more embodiments of the present invention, a low volume anilox roll is less expensive than a conventional anilox roll.

In one or more embodiments of the present invention, a low volume anilox roll is compatible with existing flexographic printing processes and systems.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A method of manufacturing a low volume transfer anilox roll comprising:
depositing a first coating material over a contact surface of a cylinder;
patterning a plurality of cells into the contact surface of the cylinder; and
depositing a second coating material over the patterned plurality of cells.

2. The method of claim 1, further comprising:
depositing a photoresist material over the deposited first coating material.

3. The method of claim 1, further comprising:
removing remaining photoresist material.

4. The method of claim 1, wherein one or more cells of the plurality of cells are hexagonal geometry.

5. The method of claim 1, wherein one or more cells of the plurality of cells have a width of approximately 5 micrometers or less.

6. The method of claim 1, wherein one or more cells of the plurality of cells are configured to hold and transfer a volume of approximately 0.3 BCM or less of ink or other material.

7. The method of claim 1, wherein a thickness of the second coating material is increased to reduce a volume of one or more cells of the plurality of cells.

8. The method of claim 1, wherein the low volume transfer anilox roll has a density in a range between approximately 2000 LPI and approximately 5000 LPI.

9. The method of claim 1, wherein the cylinder comprises a metal or metal alloy.

10. The method of claim 1, wherein the first coating material comprises a metal or metal alloy.

11. The method of claim 1, wherein the plurality of cells are patterned into the contact surface of the cylinder by a metal master process.

12. The method of claim 1, wherein the plurality of cells are patterned into the contact surface of the cylinder by a maskless lithographic process.

13. The method of claim 1, wherein the plurality of cells are patterned into the contact surface of the cylinder by an electron beam lithographic process.

14. The method of claim 1, wherein the plurality of cells are patterned into the contact surface of the cylinder by a laser ablation process.

15. The method of claim 1, wherein the plurality of cells are patterned into the contact surface of the cylinder by an UV lithographic process.

16. The method of claim 1, wherein the second coating material comprises a ceramic material.

17. The method of claim 1, wherein the second coating material is deposited by a physical vapor deposition process.

18. The method of claim 1, wherein the second coating material is deposited by a chemical vapor deposition process.

19. The method of claim 1, wherein the second coating material is deposited by an atmospheric plasma enhanced chemical vapor deposition process.

20. A low volume transfer anilox roll comprising:
a cylinder;
a roller mount disposed on a distal end of the cylinder;
a first coating layer disposed on a longitudinal contact surface around the cylinder;
a plurality of cells patterned into the cylinder; and
a second coating layer disposed over the patterned plurality of cells.
